(19) United States
(12) Patent Application Publication
(10) Pub. No.: US 2012/0118243 A1
(43) Pub. Date: May 17, 2012

(54) DOG HOUSE WITH FLOOR BELOW GROUND

(76) Inventor: Stanley S. Stanley, Jackson, GA (US)

(21) Appl. No.: 12/947,133

(22) Filed: Nov. 16, 2010

(51) Int. Cl. A01K 1/00

(52) U.S. Cl. 119/486

(57) ABSTRACT

An animal shelter may be disposed partially underground. The animal shelter may be a dog house that includes an above-ground entrance and a main portion that rests below grade. The dog house may provide more uniform temperatures for the dog, protecting the animal from both excessive heat and cold temperatures. The dog house may also provide protection from noise, allowing the dog to rest in locations with loud ambient noises. The dog house may have a dome-shaped top and an entrance-way that may keep rain out from inside of the dog house.

### BACKGROUND OF THE INVENTION

The present invention relates to animal shelters and, more particularly, to a dog house having a floor that is disposed below the ground.

Dogs may experience stress due to extreme temperatures and noise. Typical dog houses sit on top of the ground and provide little protection from noise and temperature changes.

As can be seen, there is a need for a dog house that may be disposed at least partially underground to provide a temperature controlled and quieter environment for dogs while outside.

### SUMMARY OF THE INVENTION

In one aspect of the present invention, an animal shelter comprises a floor adapted to be disposed below ground level; a cover adapted to cover the floor; an entrance portion having an opening at ground level, the opening providing a means of entry and exit from inside the animal shelter; and an entrance portion floor sloped toward the opening so that rain falling on the entrance portion floor is directed outward, away from the floor of the animal shelter.

In another aspect of the present invention, a dog house comprises a floor adapted to be disposed below ground level; side walls extending upward from the floor; a cover adapted to removably attach to the side walls to cover the floor; an entrance portion having an opening at ground level, the opening providing a means of entry and exit from inside the dog house; an entrance portion floor sloped toward the opening so that rain falling on the entrance portion floor is directed outward, away from the floor of the dog house; and a plurality of steps communicating the floor of the dog house with the entrance portion floor.

These and other features, aspects and advantages of the present invention will become better understood with reference to the following drawings, description and claims.

### BRIEF DESCRIPTION OF THE DRAWINGS

FIG. 1 is a perspective view of a dog house according to an exemplary embodiment of the present invention;

FIG. 2 is a front view of the dog house of FIG. 1; and

FIG. 3 is a cross-sectional view of the dog house of FIG. 1, taken along line 3-3 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an animal shelter that may be disposed partially underground. The animal shelter may be a dog house that includes an above-ground entrance and a main portion that rests below grade. The dog house may provide more uniform temperatures for the dog, protecting the animal from both excessive heat and cold temperatures. The dog house may also provide protection from noise, allowing the dog to rest in locations with loud ambient noises. The dog house may have a dome-shaped top and an entrance-way that may keep rain out from inside of the dog house.

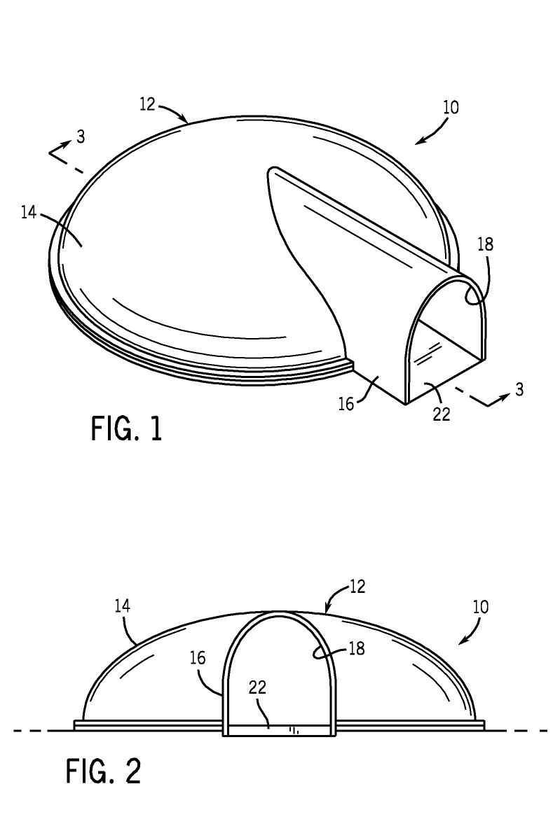

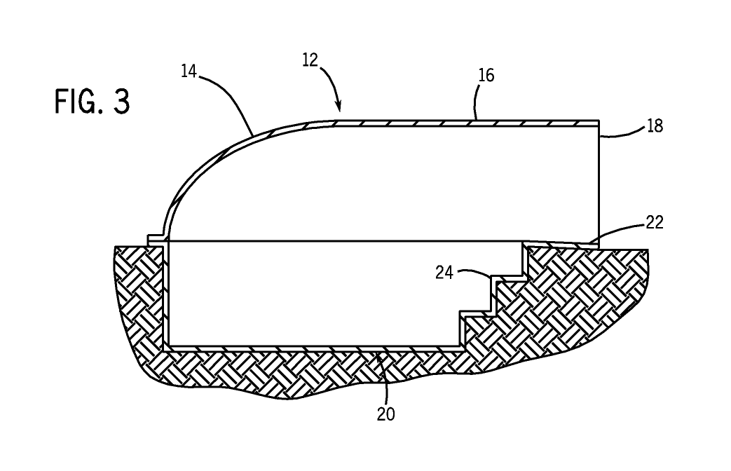

Referring to FIGS. 1 through 3, there is shown a dog house 10 according to an embodiment of the present invention. The dog house 10 may include upper components 12, such as a dome top 14 and an entrance portion 16. The entrance portion 16 may have an opening 18 for allowing an animal, such as a dog, into the dog house 10. The entrance portion 16 may extend outward from the dome top 14 to provide a sheltered entrance into the dog house 10.

The entrance portion may include an entrance ramp 22 at the bottom thereof. The entrance ramp 22 may provide a means for the animal to move through the entrance portion 16, at ground level, to a floor 20 of the dog house 10. In some embodiments, the entrance ramp 22 may include a plurality of steps 24 from ground level to the floor level.

While the Figures show a round dog house 10, the dog house may be made of various shapes depending on the size of the dog, the desired location for placement and the like. For example, for placement along a side wall of a home, a square or rectangular dog house may be useful.

In some embodiments, the dog house 10 may sit about 18 inches below ground level. Larger dog houses may sit further in the ground. The dog house 10 may have about three steps, about 6½ inches each, leading from the inside to a sloping ramp to the outside. In some embodiments, the ramp 22 may slope towards the outside of the opening 18 to help prevent rain from getting to the inside of the dog house 10. For example, with three 6½ inch steps, the steps rise 19½ inches from the floor 20 of the dog house 10. The ground level may be 18 inches from the floor 20. This extra 1½ inch may be used for draining rain away from the inside of the dog house 10. The walking surfaces of the dog house 10 may include a slip resistant material (not shown).

In some embodiments, the dome top 14 may be removable by conventional means. For example, the dome top 14 may attach to the side walls of the dog house via a clip, a hinge, a press-fit or the like. A removable dome top may allow for cleaning of the inside of the dog house.

The dog house may control the temperature therewithin. For example, on a 90 degree day, the temperature inside the dog house may be maintained below 80 degrees, typically below 75 degrees, thereby keeping the animal inside comfortable and safe.

It should be understood, of course, that the foregoing relates to exemplary embodiments of the invention and that modifications may be made without departing from the spirit and scope of the invention as set forth in the following claims.

What is claimed is:

1. An animal shelter comprising:
a floor adapted to be disposed below ground level;
a cover adapted to cover the floor;
an entrance portion having an opening at ground level, the opening providing a means of entry and exit from inside the animal shelter; and
an entrance portion floor sloped toward the opening so that rain falling on the entrance portion floor is directed outward, away from the floor of the animal shelter.

2. The animal shelter of claim 1, further comprising a plurality of steps communicating the floor of the animal shelter with the entrance portion floor.

3. The animal shelter of claim 2, wherein walking portions of the animal shelter are made slip resistant.

4. The animal shelter of claim 1, wherein the cover is removably attached to sidewalls of the animal shelter.

5. The animal shelter of claim 1, wherein the floor is adapted to be disposed about 18 inches below ground level.

6. The animal shelter of claim 1, wherein the cover is a dome-shaped cover.

7. The animal shelter of claim 1, wherein the floor of the animal shelter is circular shape.

8. A dog house comprising:
a floor adapted to be disposed below ground level;
side walls extending upward from the floor;
a cover adapted to removably attach to the side walls to cover the floor;
an entrance portion having an opening at ground level, the opening providing a means of entry and exit from inside the dog house;
an entrance portion floor sloped toward the opening so that rain falling on the entrance portion floor is directed outward, away from the floor of the dog house; and
a plurality of steps communicating the floor of the dog house with the entrance portion floor.

9. The dog house of claim 8, wherein walking portions of the animal shelter are made slip resistant.

10. The dog house of claim 8, wherein the cover is a dome-shaped cover.
